(19) United States
(12) Patent Application Publication
(10) Pub. No.: US 2011/0278914 A1
(43) Pub. Date: Nov. 17, 2011

(54) BRAKE ACTUATOR, METHOD OF OPERATING SAME, AND SYSTEM INCLUDING SAME

(76) Inventor: Jacob Kobelt, Surrey (CA)

(21) Appl. No.: 12/781,541

(22) Filed: May 17, 2010

(51) Int. Cl. B60T 13/10

(52) U.S. Cl. 303/13; 91/165

(57) ABSTRACT

A brake actuator includes an actuator body, a piston held in the actuator body, and an actuator rod coupled to the piston and coupleable to a brake to actuate the brake. A method of operating the brake actuator includes maintaining a first fluid pressure of a first fluid against a first side of the piston to urge the piston in a brake-actuating direction, and controlling a second fluid pressure of a second fluid against a second side of the piston opposite the first side of the piston to move the piston controllably in a brake-releasing direction. A brake system including the brake actuator is also disclosed.

### BACKGROUND OF THE INVENTION

1. Field of Invention

The invention relates generally to braking, and more particularly to a brake actuator, a method of operating the brake actuator, and a system including the brake actuator.

2. Description of Related Art

A conventional fail-safe brake system includes a brake actuator having a piston coupleable to a brake to actuate the brake. Such a conventional brake actuator includes one or more springs that urge the piston in a brake-actuating direction. Pressurized air, for example, controllably moves the piston in a brake-releasing direction opposite the brake-actuating direction and against the resilient force of the one or more springs to release the brake or to vary a degree of actuation of the brake. Such brake systems may be referred to as fail-safe brake systems because if a source of the pressurized air fails, the one or more springs urge the piston in the brake-actuating direction to actuate the brake.

However, the one or more springs in such a conventional fail-safe brake actuator wear over time, and exert less force as they extend from more-compressed positions to less-compressed positions. As the one or more springs wear over time, the fail-safe function of these brake systems diminishes, and therefore, disadvantageously, the one or more springs must be periodically replaced. Also, the one or more springs in these brake systems generally extend over significant lengths, thereby increasing the overall length, size, and weight of the brake actuator.

### SUMMARY OF THE INVENTION

In accordance with one aspect of the invention, there is provided a method of operating a brake actuator having a piston coupleable to a brake to actuate the brake. The method involves maintaining a first fluid pressure of a first fluid against a first side of the piston to urge the piston in a brake-actuating direction, and controlling a second fluid pressure of a second fluid against a second side of the piston opposite the first side of the piston to move the piston controllably in a brake-releasing direction opposite the brake-actuating direction.

Maintaining the first fluid pressure of the first fluid against the first side of the piston may involve supplying the first fluid through a check valve to a pressurized fluid reservoir in fluid communication with the first side of the piston, and preventing the first fluid from escaping the pressurized fluid reservoir through the check valve.

Supplying the first fluid through the check valve to the pressurized fluid reservoir may involve supplying the first fluid through the check valve to the pressurized fluid reservoir through a pressure regulator until the first fluid in the pressurized fluid reservoir reaches the first fluid pressure.

The first fluid may include gas.

Controlling the second fluid pressure of the second fluid against the second side of the piston may involve supplying the second fluid at a third fluid pressure greater than the first fluid pressure to a control valve in fluid communication with the second side of the piston.

The second fluid may include gas.

The second fluid may include hydraulic fluid.

In accordance with another aspect of the invention, there is provided a brake actuator. The brake actuator includes a piston having first and second opposite sides. The brake actuator also includes an actuator body having an inner surface defining a cavity holding the piston in sealed and slidable engagement with the inner surface such that the piston defines first and second chambers in the cavity on the first and second sides of the piston respectively, the actuator body having a first opening in fluid communication with the first chamber for receiving a first pressurized fluid, a second opening in fluid communication with the second chamber for receiving a second pressurized fluid, and a third opening in communication with the second chamber. The brake actuator also includes an actuator rod coupled to the piston on the second side of the piston, extending in sealed and slidable engagement with the actuator body through the third opening, and coupleable to a brake to actuate the brake.

In accordance with another aspect of the invention, there is provided a brake system. The brake system includes a brake actuator. The brake actuator includes a piston having first and second opposite sides. The brake actuator also includes an actuator body having an inner surface defining a cavity holding the piston in sealed and slidable engagement with the inner surface such that the piston defines first and second chambers in the cavity on the first and second sides of the piston respectively, the actuator body having a first opening in fluid communication with the first chamber for receiving a first pressurized fluid, a second opening in fluid communication with the second chamber for receiving a second pressurized fluid, and a third opening in communication with the second chamber. The brake actuator also includes an actuator rod coupled to the piston on the second side of the piston, extending in sealed and slidable engagement with the actuator body through the third opening, and coupleable to a brake to actuate the brake. The brake system also includes means, in fluid communication with the first opening of the actuator body, for maintaining a first fluid pressure of the first fluid against the first side of the piston to urge the piston and the actuator rod in a brake-actuating direction. The brake system also includes means, in fluid communication with the second opening of the actuator body, for controlling a second fluid pressure of the second fluid against the second side of the piston to move the piston and the actuator rod controllably in a brake-releasing direction opposite the brake-actuating direction.

The means for maintaining the first fluid pressure of the first fluid against the first side of the piston may include a pressurized fluid reservoir in fluid communication with the first opening of the actuator body, and a check valve in fluid communication with the pressurized fluid reservoir, the check valve configured to permit the first fluid to be supplied therethrough to the pressurized fluid reservoir and configured to prevent the first fluid from escaping the pressurized fluid reservoir therethrough.

The means for maintaining the first fluid pressure of the first fluid against the first side of the piston further may include a pressure regulator in fluid communication with the check valve and configured to permit the first fluid to be supplied to the pressurized fluid reservoir through the check valve until the first fluid in the fluid reservoir reaches the first fluid pressure.

The system may further include means for supplying the first fluid to the pressure regulator.

The first fluid may include gas.

The means for controlling the second fluid pressure of the second fluid against the second side of the piston may include a control valve in fluid communication with the second opening of the actuator body, and means for supplying the second fluid to the control valve at a third fluid pressure greater than the first fluid pressure.

The second fluid may include gas.

The second fluid may include hydraulic fluid.

In accordance with another aspect of the invention, there is provided a brake system. The brake system includes a brake actuator. The brake actuator includes a piston having first and second opposite sides. The brake actuator also includes an actuator body having an inner surface defining a cavity holding the piston in sealed and slidable engagement with the inner surface such that the piston defines first and second chambers in the cavity on the first and second sides of the piston respectively, the actuator body having a first opening in fluid communication with the first chamber for receiving a first pressurized fluid, a second opening in fluid communication with the second chamber for receiving a second pressurized fluid, and a third opening in communication with the second chamber. The brake actuator also includes an actuator rod coupled to the piston on the second side of the piston, extending in sealed and slidable engagement with the actuator body through the third opening, and coupleable to a brake to actuate the brake. The brake system also includes a first pressurized fluid source in fluid communication with the first opening of the actuator body and configured to maintain a first fluid pressure of the first fluid against the first side of the piston to urge the piston and the actuator rod in a brake-actuating direction. The brake system also includes a second pressurized fluid source in fluid communication with the second opening of the actuator body and configured to control a second fluid pressure of the second fluid against the second side of the piston to move the piston and the actuator rod controllably in a brake-releasing direction opposite the brake-actuating direction.

The first pressurized fluid source may include a pressurized fluid reservoir in fluid communication with the first opening of the actuator body, and a check valve in fluid communication with the pressurized fluid reservoir, the check valve configured to permit the first fluid to be supplied therethrough to the pressurized fluid reservoir and configured to prevent the first fluid from escaping the pressurized fluid reservoir therethrough.

The first pressurized fluid source may further include a pressure regulator in fluid communication with the check valve and configured to permit the first fluid to be supplied to the pressurized fluid reservoir through the check valve until the first fluid in the fluid reservoir reaches the first fluid pressure.

The system may further include a first fluid pump for supplying the first fluid to the pressure regulator.

The first fluid may include gas.

The second fluid source may include a control valve in fluid communication with the second opening of the actuator body, and a second fluid pump for supplying the second fluid to the control valve at a third fluid pressure greater than the first fluid pressure.

The second fluid may include gas.

The second fluid may include hydraulic fluid.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings that illustrate embodiments of the invention:

FIG. 1 is a schematic view of a brake system in accordance with a first embodiment of the invention;

FIG. 2 is a cross-sectional view of a brake actuator of the brake system of FIG. 1; and

FIG. 3 is a schematic view of a brake system in accordance with another embodiment of the invention.

### DETAILED DESCRIPTION

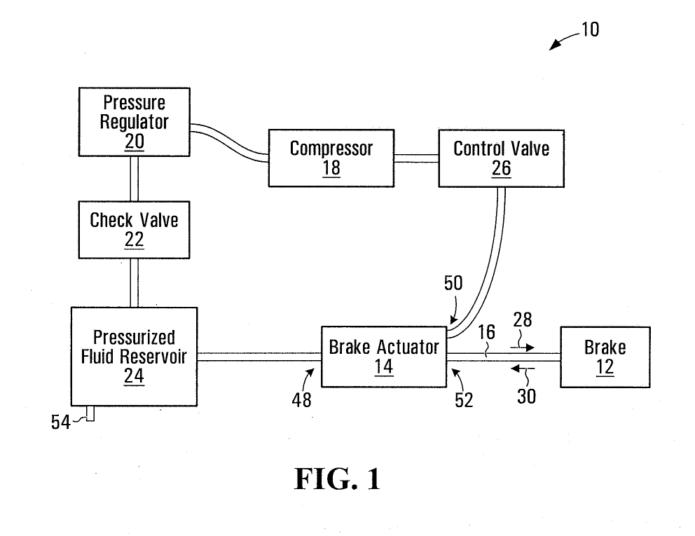

Referring to FIG. 1, a brake system in accordance with a first embodiment of the invention is shown generally at 10. The brake system 10 includes a brake 12 and a brake actuator 14 having an actuator rod 16 coupled to the brake 12 to actuate the brake 12. The brake system 10 also includes a compressor 18, a pressure regulator 20, a check valve 22, a pressurized fluid reservoir 24, and a control valve 26.

In the embodiment shown, the brake 12 is a conventional disc brake. The brake 12 is actuated when the actuator rod 16 is moved in a brake-actuating direction indicated by the arrow 28, and is released when the actuator rod 16 is moved in a brake-releasing direction indicated by the arrow 30 and opposite the brake-actuating direction.

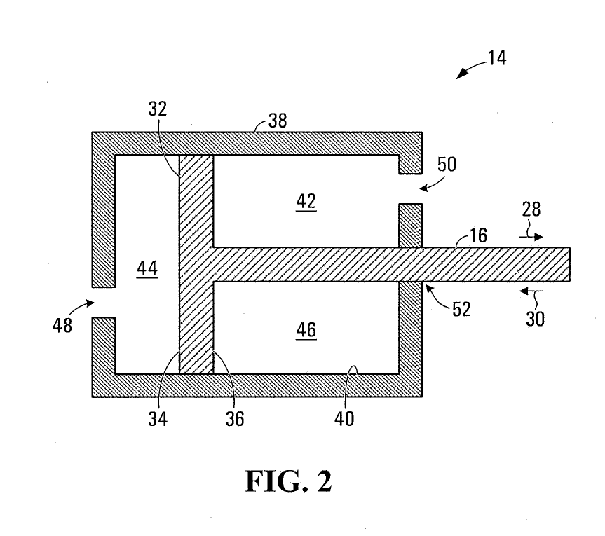

Referring to FIG. 2, the brake actuator 14 includes a piston 32 having a first side 34 and a second side 36 opposite the first side 34. The brake actuator 14 also includes an actuator body 38 having an inner surface 40 defining a cavity 42. The cavity 42 holds the piston 32 in sealed and slidable engagement with the inner surface 40 such that the piston defines first and second chambers 44 and 46 in the cavity 42 on the first and second sides 34 and 36 of the piston 32 respectively.

The actuator body 38 has a first opening shown generally at 48 in fluid communication with the first chamber 44, a second opening shown generally at 50 in fluid communication with the second chamber 46, and a third opening shown generally at 52 in communication with the second chamber 46. The actuator rod 16 is coupled to the piston 32 on the second side 36 of the piston 32, and extends in sealed and slidable engagement with the actuator body 38 through the third opening 52.

Referring back to FIG. 1, the compressor 18 in the embodiment shown supplies pressurized gas (such as ambient atmospheric air, for example) to the pressure regulator 20. Alternatively, the compressor 18 may be replaced with a fluid pump to supply any pressurized fluid to the pressure regulator 20, and the compressor 18 may more generally be referred to as a “fluid pump”.

The pressure regulator 20 in the embodiment shown receives pressurized gas from the compressor 18, and is configured to supply the pressurized gas from the compressor 18 through the check valve 22 to the pressurized fluid reservoir 24 until the gas in the pressurized fluid reservoir 24 reaches a first fluid pressure.

The check valve 22 in the embodiment shown permits pressurized gas received from the pressure regulator 20 to be supplied therethrough to the pressurized fluid reservoir 24, and prevents pressurized gas from escaping from the pressurized fluid reservoir 24 therethrough.

Therefore, the compressor 18, the pressure regulator 20, and the check valve 22 maintain pressurized gas in the pressurized fluid reservoir 24 at the first fluid pressure. However, in alternative embodiments, these components may be configured to maintain any fluid in the pressurized fluid reservoir 24 at such a first fluid pressure.

In the embodiment shown, the pressurized fluid reservoir 24 has a drain cock 54 openable to release pressurized gas from the pressurized fluid reservoir 24, although the drain cock 54 is closed during normal operation. Referring to FIGS. 1 and 2, the pressurized fluid reservoir 24 is in fluid communication with the first chamber 44 of the brake actuator 14 through the first opening 48 of the actuator body 38. Therefore, the first chamber 44 of the brake actuator 14 receives a first fluid (which, in the embodiment shown, is gas) from the pressurized fluid reservoir 24 at the first fluid pressure, and the compressor 18, the pressure regulator 20, the check valve 22, and the pressurized fluid reservoir 24 function as a first pressurized fluid source in fluid communication with the first opening 48 of the actuator body 38 to maintain the first fluid pressure of the first fluid against the first side 34 of the piston 32 to urge the piston 32 and the actuator rod 16 in the brake-actuating direction shown by the arrow 28. In alternative embodiments, the brake actuator 14 may further include one or more springs (not shown) in the first chamber 44, for example, to supplement the force from the first fluid pressure of the first fluid on the piston 32 in the brake-actuating direction shown by the arrow 28.

Referring back to FIG. 1, in the embodiment shown, the compressor 18 also supplies pressurized gas (such as ambient atmospheric air, for example) to the control valve 26 at a fluid pressure greater than the first fluid pressure. The control valve 26 is in communication with a brake pedal (not shown) to control a degree of brake actuation of the brake actuator 14 on the brake 12. The control valve 26 is also in fluid communication with the second side 36 of the piston 32 and the second chamber 46 of the brake actuator 14 through the second opening 50 of the actuator body 38, and the second chamber 46 therefore receives a second fluid (which, in the embodiment shown, is also gas) from the control valve 26. The control valve 26 controls a second pressure of the second fluid against the second side 36 of the piston 32 by controllably regulating the pressure of the pressurized gas received from the compressor 18 in response to actuation of the brake pedal (not shown).

In operation, in the embodiment shown, the compressor 18, the pressure regulator 20, the check valve 22, and the pressurized fluid reservoir 24 maintain the generally constant first fluid pressure of the first fluid in the first chamber 44 and against the first side 34 of the piston 32. In order to actuate the brake 12 or increase a degree of actuation of the brake 12, the control valve 26 reduces a second fluid pressure of the second fluid in the second chamber 46 and against the second side 36 of the piston 32 such that the first fluid pressure of the first fluid in the first chamber 44 against the first side 34 of the piston 32 exceeds the second fluid pressure, thereby causing the piston 32 and the actuator rod 16 move in the brake-actuating direction shown by the arrow 28 to actuate the brake 12. Alternatively, in order to release the brake 12 or reduce a degree of actuation of the brake 12, the control valve 26 increases the second fluid pressure of the second fluid in the second chamber 46 and against the second side 36 of the piston 32 to such that the second fluid pressure exceeds the first fluid pressure of the first fluid in the first chamber 44 and against the first side 34 of the piston 32, thereby causing the piston 32 and the actuator rod 16 to move in the brake-releasing direction shown by the arrow 30.

Therefore, actuation of the brake pedal (not shown) regulates the second pressure of the second fluid against the second side 36 of the piston 32 to move the piston 32 controllably in either the brake-actuating direction shown by the arrow 28 or in the brake-releasing direction shown by the arrow 30, and therefore the compressor 18 and the control valve 26 function as a second pressurized fluid source in fluid communication with the second chamber 46 and the second side 36 of the piston 32 through the second opening 50 of the actuator body 38 to control the second fluid pressure of the second fluid against the second side 36 of the piston 32 and move the piston 32 and the actuator rod 16 controllably in, for example, the brake-releasing direction shown by the arrow 30.

Advantageously, in the event of failure of one or both of the compressor 18 and the control valve 26, the pressurized fluid reservoir 24 maintains the first pressure of air in the first chamber 44 of the brake actuator 14 and against the first side 34 of the piston 32, thereby urging the piston 32 and the actuator rod 16 in the brake-actuating direction shown by the arrow 28. Because the brake 12 is actuated in response to failure of one or both of the compressor 18 and the control valve 26, the brake system 10 may be referred to as a fail-safe brake system.

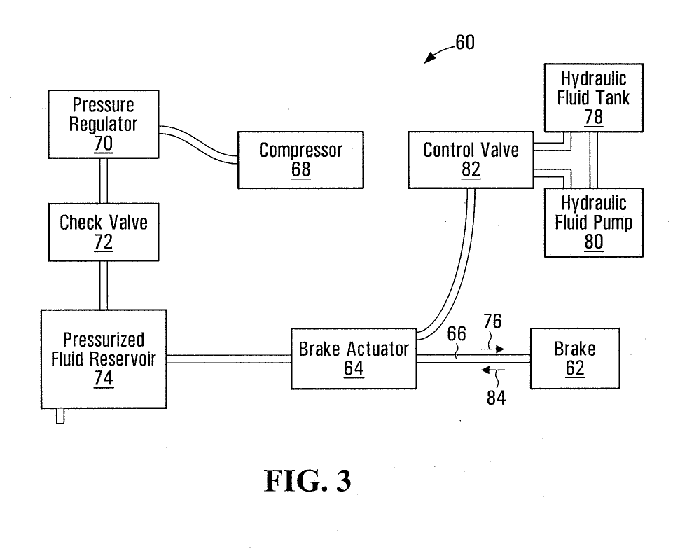

Referring to FIG. 3, a brake system in accordance with another embodiment of the invention is shown generally at 60. The brake system 60 includes a brake 62 and a brake actuator 64 having an actuator rod 66 coupled to the brake 62 to actuate the brake 62. The brake 62, the brake actuator 64, and the actuator rod 66 in the embodiment shown are substantially the same as the brake 12, the brake actuator 14, and the actuator rod 16 respectively discussed above and shown in FIGS. 1 and 2.

The brake system 60 also includes a compressor 68, a pressure regulator 70, a check valve 72, and a pressurized fluid reservoir 74. The compressor 68, the pressure regulator 70, the check valve 72, and the pressurized fluid reservoir 74 in the embodiment shown are substantially the same as the compressor 18, the pressure regulator 20, the check valve 22, and the pressurized fluid reservoir 24 respectively discussed above and shown in FIG. 1. Therefore, the compressor 68, the pressure regulator 70, and the check valve 72 maintain a first fluid (which, in the embodiment shown, is gas) in the pressurized fluid reservoir 74 at a first fluid pressure.

The pressurized fluid reservoir 74 is in fluid communication with a first chamber of the brake actuator 64 (corresponding to the first chamber 44 of the brake actuator 14 shown in FIG. 2) through a first opening of an actuator body of the brake actuator 64 (corresponding to the first opening 48 of the actuator body 38 of the brake actuator 14 shown in FIG. 2), and therefore in the embodiment shown, the first chamber of the brake actuator 64 receives the first fluid from the pressurized fluid reservoir 74 at the first fluid pressure, and the compressor 68, the pressure regulator 70, the check valve 72, and the pressurized fluid reservoir 74 function as a first pressurized fluid source in fluid communication with the first opening of the actuator body of the brake actuator 64 to maintain the first fluid pressure of the first fluid against a first side of the piston of the brake actuator 64 (corresponding to the first side 34 of the piston 32 of the brake actuator 14 shown in FIG. 2) to urge the piston of the brake actuator 64 and the actuator rod 66 in a brake-actuating direction shown by the arrow 76 to actuate the brake 62.

The brake system 10 also includes a hydraulic fluid tank 78 for storing hydraulic fluid, a hydraulic fluid pump 80 in fluid communication with the hydraulic fluid tank 78, and a control valve 82. In the embodiment shown, the hydraulic fluid pump 80 supplies pressurized hydraulic fluid from the hydraulic fluid tank 78 to the control valve 82 at a pressure greater than the first fluid pressure. The control valve 82 is in communication with a brake pedal (not shown) to control a degree of brake actuation of the brake actuator 64 on the brake 62. The control valve 82 is also in fluid communication with a second side of the piston of the brake actuator 64 (corresponding to the second side 36 of the piston 32 of the brake actuator 14 shown in FIG. 2) through a second opening of the actuator body of the brake actuator 64 (corresponding to the second opening 50 of the actuator body 38 of the brake actuator 14 shown in FIG. 2), and the second chamber of the brake actuator 64 therefore receives a second fluid (which, in the embodiment shown, is hydraulic fluid) from the control valve 82. The control valve 82 controls a second pressure of the second fluid against the second side of the piston of the brake actuator 64 by controllably regulating the pressure of the pressurized hydraulic fluid received from the hydraulic fluid pump 80 in response to actuation of the brake pedal (not shown).

The hydraulic fluid tank 78, the hydraulic fluid pump 80, and the control valve 82 therefore function as a second pressurized fluid source in fluid communication with the second chamber of the brake actuator 64 and the second side of the piston of the brake actuator 64 through the second opening of the actuator body of the brake actuator 64 to control the second fluid pressure of the second fluid against the second side of the piston of the brake actuator 64 and move the piston of the brake actuator 64 and the actuator rod 66 controllably in a brake-releasing direction shown by the arrow 84 opposite the brake-actuating direction shown by the arrow 76. The control valve 82 is also in fluid communication directly with the hydraulic fluid tank 78, to facilitate restoring hydraulic fluid to the hydraulic fluid tank 78 when the second chamber of the brake actuator 64 contracts in response to movement of the piston of the brake actuator 64 in the brake-actuating direction shown by the arrow 76. In summary, the brake system 60 functions in substantially the same way as the brake system 10, although in the brake system 60, the second fluid is hydraulic fluid, whereas in the brake system 10, the second fluid is gas.

While specific embodiments of the invention have been described and illustrated, such embodiments should be considered illustrative of the invention only and not as limiting the invention as construed in accordance with the accompanying claims.

What is claimed is:

1. A method of operating a brake actuator having a piston coupleable to a brake to actuate the brake, the method comprising:
maintaining a first fluid pressure of a first fluid against a first side of the piston to urge the piston in a brake-actuating direction; and
controlling a second fluid pressure of a second fluid against a second side of the piston opposite the first side of the piston to move the piston controllably in a brake-releasing direction opposite the brake-actuating direction.

2. The method of claim 1 wherein maintaining the first fluid pressure of the first fluid against the first side of the piston comprises:
supplying the first fluid through a check valve to a pressurized fluid reservoir in fluid communication with the first side of the piston; and
preventing the first fluid from escaping the pressurized fluid reservoir through the check valve.

3. The method of claim 2 wherein supplying the first fluid through the check valve to the pressurized fluid reservoir comprises supplying the first fluid through the check valve to the pressurized fluid reservoir through a pressure regulator until the first fluid in the pressurized fluid reservoir reaches the first fluid pressure.

4. The method of claim 1 wherein the first fluid comprises gas.

5. The method of claim 1 wherein controlling the second fluid pressure of the second fluid against the second side of the piston comprises supplying the second fluid at a third fluid pressure greater than the first fluid pressure to a control valve in fluid communication with the second side of the piston.

6. The method of claim 1 wherein the second fluid comprises gas.

7. The method of claim 1 wherein the second fluid comprises hydraulic fluid.

8. A brake actuator comprising:
a piston having first and second opposite sides;
an actuator body having an inner surface defining a cavity holding the piston in sealed and slidable engagement with the inner surface such that the piston defines first and second chambers in the cavity on the first and second sides of the piston respectively, the actuator body having a first opening in fluid communication with the first chamber for receiving a first pressurized fluid, a second opening in fluid communication with the second chamber for receiving a second pressurized fluid, and a third opening in communication with the second chamber; and
an actuator rod coupled to the piston on the second side of the piston, extending in sealed and slidable engagement with the actuator body through the third opening, and coupleable to a brake to actuate the brake.

9. A brake system comprising:
a brake actuator comprising:
a piston having first and second opposite sides;
an actuator body having an inner surface defining a cavity holding the piston in sealed and slidable engagement with the inner surface such that the piston defines first and second chambers in the cavity on the first and second sides of the piston respectively, the actuator body having a first opening in fluid communication with the first chamber for receiving a first pressurized fluid, a second opening in fluid communication with the second chamber for receiving a second pressurized fluid, and a third opening in communication with the second chamber; and
an actuator rod coupled to the piston on the second side of the piston, extending in sealed and slidable engagement with the actuator body through the third opening, and coupleable to a brake to actuate the brake;
means, in fluid communication with the first opening of the actuator body, for maintaining a first fluid pressure of the first fluid against the first side of the piston to urge the piston and the actuator rod in a brake-actuating direction; and
means, in fluid communication with the second opening of the actuator body, for controlling a second fluid pressure of the second fluid against the second side of the piston to move the piston and the actuator rod controllably in a brake-releasing direction opposite the brake-actuating direction.

10. The system of claim 9 wherein the means for maintaining the first fluid pressure of the first fluid against the first side of the piston comprises:
a pressurized fluid reservoir in fluid communication with the first opening of the actuator body; and
a check valve in fluid communication with the pressurized fluid reservoir, the check valve configured to permit the first fluid to be supplied therethrough to the pressurized fluid reservoir and configured to prevent the first fluid from escaping the pressurized fluid reservoir therethrough.

11. The system of claim 10 wherein the means for maintaining the first fluid pressure of the first fluid against the first side of the piston further comprises a pressure regulator in fluid communication with the check valve and configured to permit the first fluid to be supplied to the pressurized fluid reservoir through the check valve until the first fluid in the fluid reservoir reaches the first fluid pressure.

12. The system of claim 11 further comprising means for supplying the first fluid to the pressure regulator.

13. The system claim 9 wherein the first fluid comprises gas.

14. The system of claim 9 wherein the means for controlling the second fluid pressure of the second fluid against the second side of the piston comprises:
a control valve in fluid communication with the second opening of the actuator body; and
means for supplying the second fluid to the control valve at a third fluid pressure greater than the first fluid pressure.

15. The system of claim 9 wherein the second fluid comprises gas.

16. The system of claim 9 wherein the second fluid comprises hydraulic fluid.

17. A brake system comprising:
a brake actuator comprising:
a piston having first and second opposite sides;
an actuator body having an inner surface defining a cavity holding the piston in sealed and slidable engagement with the inner surface such that the piston defines first and second chambers in the cavity on the first and second sides of the piston respectively, the actuator body having a first opening in fluid communication with the first chamber for receiving a first pressurized fluid, a second opening in fluid communication with the second chamber for receiving a second pressurized fluid, and a third opening in communication with the second chamber; and
an actuator rod coupled to the piston on the second side of the piston, extending in sealed and slidable engagement with the actuator body through the third opening, and coupleable to a brake to actuate the brake;
a first pressurized fluid source in fluid communication with the first opening of the actuator body and configured to maintain a first fluid pressure of the first fluid against the first side of the piston to urge the piston and the actuator rod in a brake-actuating direction; and
a second pressurized fluid source in fluid communication with the second opening of the actuator body and configured to control a second fluid pressure of the second fluid against the second side of the piston to move the piston and the actuator rod controllably in a brake-releasing direction opposite the brake-actuating direction.

18. The system of claim 17 wherein the first pressurized fluid source comprises:
a pressurized fluid reservoir in fluid communication with the first opening of the actuator body; and
a check valve in fluid communication with the pressurized fluid reservoir, the check valve configured to permit the first fluid to be supplied therethrough to the pressurized fluid reservoir and configured to prevent the first fluid from escaping the pressurized fluid reservoir therethrough.

19. The system of claim 18 wherein the first pressurized fluid source further comprises a pressure regulator in fluid communication with the check valve and configured to permit the first fluid to be supplied to the pressurized fluid reservoir through the check valve until the first fluid in the fluid reservoir reaches the first fluid pressure.

20. The system of claim 19 further comprising a first fluid pump for supplying the first fluid to the pressure regulator.

21. The system of claim 17 wherein the first fluid comprises gas.

22. The system of claim 17 wherein the second fluid source comprises:
a control valve in fluid communication with the second opening of the actuator body; and
a second fluid pump for supplying the second fluid to the control valve at a third fluid pressure greater than the first fluid pressure.

23. The system of claim 17 wherein the second fluid comprises gas.

24. The system of claim 17 wherein the second fluid comprises hydraulic fluid.
